(19) United States
(12) Patent Application Publication
(10) Pub. No.: US 2024/0013197 A1
(43) Pub. Date: Jan. 11, 2024

(54) SYSTEM FOR OBFUSCATION OF NETWORK IDENTITY TO PREVENT DATA EXFILTRATION

(71) Applicant: BANK OF AMERICA CORPORATION, Charlotte, NC (US)

(72) Inventors: Paul Martin Mattison, Sherrills Ford, NC (US); Matthew Edward Williams, Frisco, TX (US)

(73) Assignee: BANK OF AMERICA CORPORATION, Charlotte, NC (US)

(21) Appl. No.: 17/859,585

(22) Filed: Jul. 7, 2022

(51) Int. Cl. G06Q 20/36; H04L 9/40; G06Q 20/40

(52) U.S. Cl. CPC G06Q 20/363; H04L 63/0407; G06Q 20/401; G06Q 2220/00

(57) ABSTRACT

Systems, computer program products, and methods are described herein for obfuscation of network identity to prevent data exfiltration. The present invention is configured to receive, from an external device, a first instance of transfer of resources to a user; store the resources in a cryptographic digital wallet associated with the user; record the first instance of the transfer of the resources in a first distributed ledger; automatically transfer the resources from the cryptographic digital wallet to a resource repository associated with the user; record the transfer of the resources from the cryptographic digital wallet to the resource repository in the first distributed ledger; electronically receive, from a user input device, a first instance of distribution of a first portion of the resources from the resource repository to an end-point device; and record the first instance of distribution of the first portion of the resources in a second distributed ledger.

### FIELD OF THE INVENTION

The present invention embraces a system for obfuscation of network identity to prevent data exfiltration.

### BACKGROUND

Central Bank Digital Currency (CBDC) is managed using distributed ledger technology, expediting, and increasing the security of resource transfers (e.g., payments) between entities such as banks, institutions, and individuals, with each entity operating as nodes on a federal distributed ledger technology (DLT) network. However, any distributed ledger used to record such resource transfers is likely to be a public distributed ledger that is permissionless, giving access to recorded information on the distributed ledger to anyone in the network.

Therefore, there is a need for a system for obfuscation of network identity to prevent data exfiltration.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for obfuscation of network identity to prevent data exfiltration is presented. The system comprising: at least one non-transitory storage device; and at least one processor coupled to the at least one non-transitory storage device, wherein the at least one processor is configured to: receive, from an external device, a first instance of transfer of resources to a user; store the resources in a cryptographic digital wallet associated with the user; record the first instance of the transfer of the resources in a first distributed ledger, wherein the first distributed ledger is a public distributed ledger; automatically transfer the resources from the cryptographic digital wallet to a resource repository associated with the user; record the transfer of the resources from the cryptographic digital wallet to the resource repository in the first distributed ledger; electronically receive, from a user input device, a first instance of distribution of a first portion of the resources from the resource repository to an end-point device; and record the first instance of distribution of the first portion of the resources in a second distributed ledger, wherein the second distributed ledger is a private distributed ledger associated with an entity.

In some embodiments, the at least one processor is further configured to: electronically receive, from a user input device, a first private key associated with the cryptographic digital wallet; and execute, using the first private key, the transfer of the resources from the cryptographic digital wallet to the resource repository.

In some embodiments, recording the transfer of the resources from the cryptographic digital wallet to the resource repository in the first distributed ledger further comprises: generating a first transaction object for the transfer of the resources; and deploying the first transaction object in the first distributed ledger.

In some embodiments, deploying the first transaction object further comprises: capturing a first distributed ledger address associated with the recording; generating a first notification indicating that the first transaction object has been created for the transfer of resources in the first distributed ledger, wherein the first notification comprises at least the first distributed ledger address; and transmit control signals configured to cause the user input device to display the first notification.

In some embodiments, the recording of the transfer of the resources from the cryptographic digital wallet to the resource repository in the first distributed ledger is publicly accessible.

In some embodiments, recording the first instance of distribution of the first portion of the resources in the second distributed ledger further comprises: generating a second transaction object for the first instance of distribution of the first portion of the resources; and deploying the second transaction object in the first distributed ledger.

In some embodiments, deploying the second transaction object further comprises: capturing a second distributed ledger address associated with the recording; generating a second notification indicating that the second transaction object has been created for the transfer of resources in the second distributed ledger, wherein the second notification comprises at least the second distributed ledger address; and transmitting control signals configured to cause the user input device to display the second notification.

In some embodiments, the recording of the first instance of distribution of the first portion of the resources in the second distributed ledger is accessible only to users with permissioned access to the second distributed ledger.

In another aspect, a computer program product for obfuscation of network identity to prevent data exfiltration is presented. The computer program product comprising a non-transitory computer-readable medium comprising code causing an apparatus to: receive, from an external device, a first instance of transfer of resources to a user; store the resources in a cryptographic digital wallet associated with the user; record the first instance of the transfer of the resources in a first distributed ledger, wherein the first distributed ledger is a public distributed ledger; automatically transfer the resources from the cryptographic digital wallet to a resource repository associated with the user; record the transfer of the resources from the cryptographic digital wallet to the resource repository in the first distributed ledger; electronically receive, from a user input device, a first instance of distribution of a first portion of the resources from the resource repository to an end-point device; and record the first instance of distribution of the first portion of the resources in a second distributed ledger, wherein the second distributed ledger is a private distributed ledger associated with an entity.

In yet another aspect, a method for obfuscation of network identity to prevent data exfiltration is presented. The method comprising: receiving, from an external device, a first instance of transfer of resources to a user; storing the resources in a cryptographic digital wallet associated with the user; recording the first instance of the transfer of the resources in a first distributed ledger, wherein the first distributed ledger is a public distributed ledger; automatically transferring the resources from the cryptographic digital wallet to a resource repository associated with the user; recording the transfer of the resources from the cryptographic digital wallet to the resource repository in the first distributed ledger; electronically receiving, from a user input device, a first instance of distribution of a first portion of the resources from the resource repository to an end-point device; and recording the first instance of distribution of the first portion of the resources in a second distributed ledger, wherein the second distributed ledger is a private distributed ledger associated with an entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for obfuscation of network identity to prevent data exfiltration, in accordance with an embodiment of the invention;

FIGS. 2A-2B illustrate an exemplary distributed ledger technology (DLT) architecture, in accordance with an embodiment of the invention; and

FIG. 3 illustrates a process flow for obfuscation of network identity to prevent data exfiltration, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

Central Bank Digital Currency (CBDC) is a digital form of central bank money, which is legal tender created and backed by a central bank that represents a claim against the central bank and not against a commercial bank or a Payment Service Provider (PSP). CBDC is managed using distributed ledger technology, expediting, and increasing the security of resource transfers (e.g., payments) between entities such as banks, institutions, and individuals, with each entity operating as nodes on a federal distributed ledger technology (DLT) network. However, any distributed ledger used to record such resource transfers is likely to be a public distributed ledger that is permissionless, giving access to recorded information on the distributed ledger to anyone in the network. Should CBDC be used by institutions such as employers to pay employees in the future, these transactions are going to be recorded in the public distributed ledger. In addition, any transaction executed by the user using these funds are also going to be recorded in the public distributed ledger, giving the user little to no financial privacy. Therefore, there is a need for a system for obfuscation of network identity to prevent data exfiltration.

Accordingly, the present invention, (i) Receives, from an external device, a first instance of transfer of resources (initial deposit of funds) to a user. The external device may be associated with any institution that uses CBDC as part of transferring resources to the user, which requires the institution to record each instance of transfer of resources on a public distributed ledger. E.g., the institution may be a federal bank that disburses funds to the general public, an employer who disburses periodic salaries to their employees, and/or the like, (ii) Stores the resources in a cryptographic digital wallet associated with the user. The cryptographic digital wallet may be a secure hardware device that can be used securely and interactively using private/public keys, capable of storing digital resources. The cryptographic digital wallet may be integrated with the user input device, embedded thereon using application-specific circuitry. The cryptographic digital wallet may be firewalled off from any existing digital wallets (e.g., resource repositories) associated with the user input device. The cryptographic digital wallet may be a stand-alone hardware wallet, (iii) Records the first instance of the transfer of the resources in a first distributed ledger. The first distributed ledger is a public distributed ledger, (iv) Transfers the resources from the cryptographic digital wallet to a resource repository associated with the user. The user may be required to provide a private/public key associated with the cryptographic digital wallet proving ownership over the wallet to initiate the resource transfer, (v) Records the transfer of the resources from the cryptographic digital wallet to the resource repository in the first distributed ledger. As the transfer includes the use of the cryptographic digital wallet, the transfer of resources from the cryptographic digital wallet to a resource repository may also need to be recorded in the first distributed ledger. In some cases, the transfer of resources from the cryptographic digital wallet to a resource repository may not be recorded in the first distributed ledger, (vi) Receives, from a user input device, a first instance of distribution of a first portion of the resources from the resource repository to an end-point device. These instances of distribution of portions of resources may refer to any subsequent transactions the user may wish to execute the resources (e.g., funds) in the resource repository. Records the first instance of distribution of the first portion of the resources in a second distributed ledger. The second distributed ledger is a private distributed ledger associated with an entity. The recording of the first instance of distribution of the first portion of the resources in the second distributed ledger is accessible only to users with permissioned access to the second distributed ledger, (vii) While it would not be impossible to tie transactions back to the user, it would require additional official permission for divulgence, (viii) This further allows the entity, i.e., the financial institution to continue to operate as a node in the first distributed ledger, while providing data privacy to the users preventing any unauthorized data exfiltration.

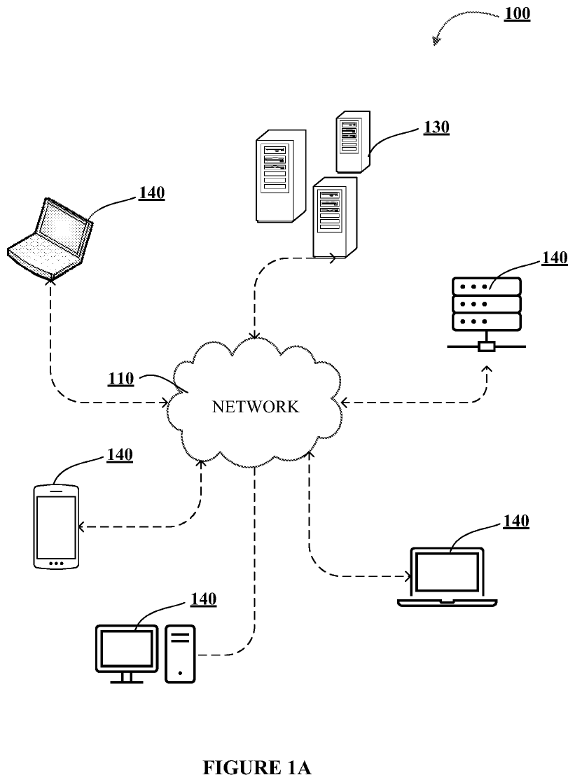

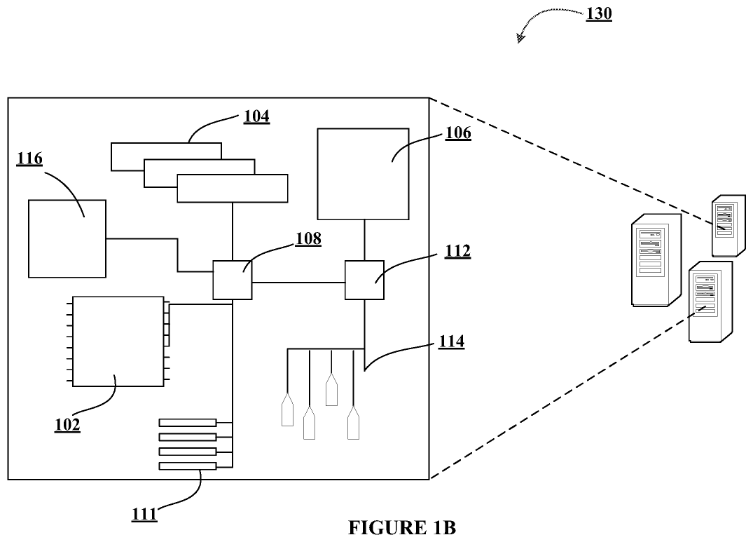

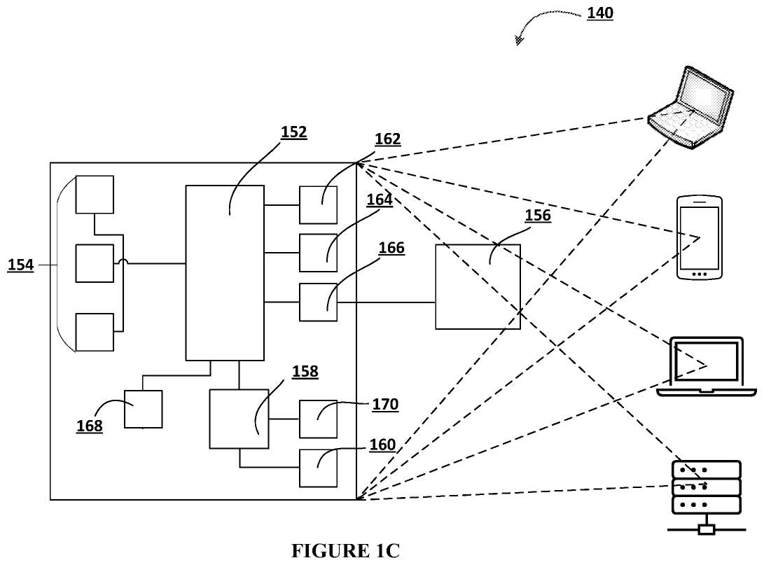

FIGS. 1A-1C illustrate technical components of an exemplary distributed computing environment for obfuscation of network identity to prevent data exfiltration 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

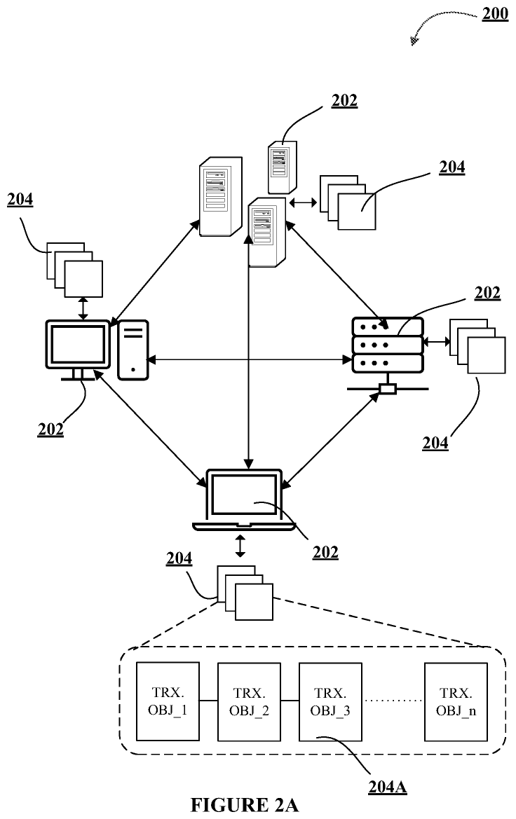

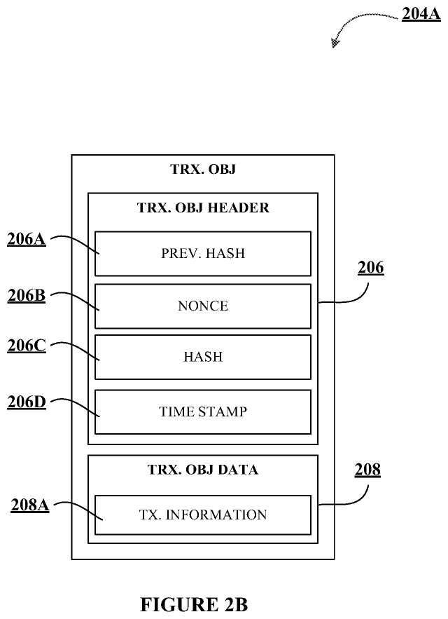

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps. In some embodiments, to permit such transactions and agreements to be carried out, i.e., to execute the smart contract, the user may be required to provide authorization in the form of non-fungible tokens (NFTs). Here, the NFT may be a cryptographic record (referred to as “tokens”) representing multi-layered documentation that identifies the user and their ownership interest in the transactions to be executed.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

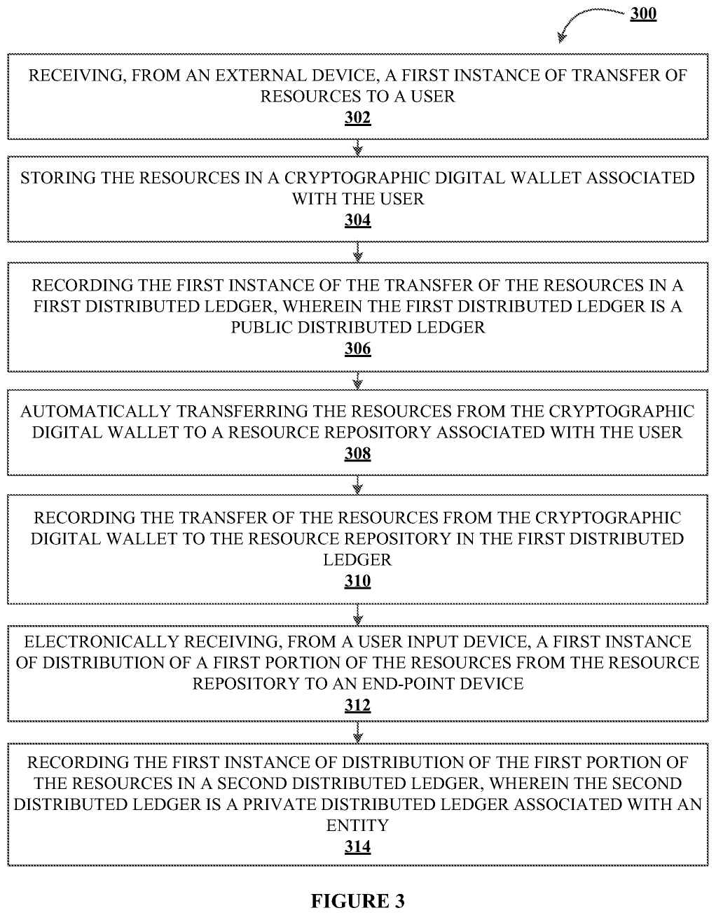

FIG. 3 illustrates a process flow for obfuscation of network identity to prevent data exfiltration 300, in accordance with an embodiment of the invention. As shown in block 302, the process flow includes receiving, from an external device, a first instance of transfer of resources to a user. Here, the external device may be associated with any institution that uses CBDC as part of transferring resources to the user, which requires the institution to record each instance of transfer of resources on a public distributed ledger. For example, the institution may be a federal bank that disburses funds to the general public, an employer who disburses periodic salaries to their employees, and/or the like.

Next, as shown in block 304, the process flow includes storing the resources in a cryptographic digital wallet associated with the user. In some embodiments, the cryptographic digital wallet may be a component of the distributed ledger ecosystem that provides security and utility. Accordingly, the cryptographic digital wallet may be a secure hardware device that can be used securely and interactively using private/public keys, capable of storing digital resources (such as CBDC). In one aspect, the cryptographic digital wallet may be integrated with the user input device, embedded thereon using application-specific circuitry. In such cases, the cryptographic digital wallet may be firewalled off from any existing digital wallets (e.g., resource repositories) associated with the user input device. In another aspect, the cryptographic digital wallet may be a stand-alone hardware wallet.

Next, as shown in block 306, the process flow includes recording the first instance of the transfer of the resources in a first distributed ledger, wherein the first distributed ledger is a public distributed ledger. In a typical CBDC transaction, resources distributed to the user is stored in a repository. The user may retrieve funds from this repository and execute transactions on a day-to-day basis. Each transaction executed is recorded on the first distributed ledger, giving the user little to no financial privacy as such a recording is publicly accessible. By introducing a cryptographic digital wallet as an intermediary, resources that are typically stored in the repository are instead transferred to the cryptographic digital wallet that may be identified using an alpha-numeric string, keeping the identity of the user anonymous. Accordingly, when the first instance of the transfer of resources is recorded in the public distributed ledger, i.e., the first distributed ledger, the publicly available information only identifies the cryptographic digital wallet and obfuscates any identifiable user information.

As described herein, to record the transfer of resources from the cryptographic digital wallet to the resource repository in the first distributed ledger, the system may be configured to generate a first transaction object for the transfer of the resources, and then deploy the first transaction object in the first distributed ledger. To deploy the first transaction object, the system may be configured to capture the first distributed ledger address associated with the recording, and then notify the user of the deployment by providing the first distributed ledger address.

Next, as shown in block 308, the process flow includes automatically transferring the resources from the cryptographic digital wallet to a resource repository associated with the user. Here, the resource repository may be financial account maintained by an entity (e.g., a financial institution) in which the resource transfers between the entity and the user are recorded. As resources are received into the cryptographic digital wallet, they may be automatically transferred to a resource repository. In this regard, the user may be required to provide a private/public key associated with the cryptographic digital wallet proving ownership over the wallet to initiate the resource transfer. In some embodiments, the user may be able to schedule an automatic transfer of a portion of the resources on a periodic basis. In some other embodiments, the entity may be able to schedule an automatic transfer of a portion of the resources on a periodic basis. In still other embodiments, the transfer may be initiated on demand.

Next, as shown in block 310, the process flow includes recording the transfer of the resources from the cryptographic digital wallet to the resource repository in the first distributed ledger. As the transfer includes the use of the cryptographic digital wallet, the transfer of resources from the cryptographic digital wallet to a resource repository may also need to be recorded in the first distributed ledger. Once the resources are transferred from the cryptographic digital wallet to the resource repository, any subsequent transfers are no longer subject to recording in the first distributed ledger. In some embodiments, the transfer of resources from the cryptographic digital wallet to a resource repository may not be recorded in the first distributed ledger.

Next, as shown in block 312, the process flow includes electronically receiving, from a user input device, a first instance of distribution of a first portion of the resources from the resource repository to an end-point device. In some embodiments, these instances of distribution of portions of resources may refer to any subsequent transactions the user may wish to execute the resources (e.g., funds) in the resource repository.

Next, as shown in block 314, the process flow includes recording the first instance of distribution of the first portion of the resources in a second distributed ledger, wherein the second distributed ledger is a private distributed ledger associated with an entity. While the subsequent instances of distribution of portions of resources may not be subject to recording in the public distributed ledger, i.e., the first distributed ledger, they may still be subject to recording in a second distributed ledger, a private distributed ledger maintained by the same entity that also maintains the resource repository. The private (or permissioned) distributed ledger may be a distributed ledger that allows only a selected entry of verified participants through an authentic and verified invitation. Therefore, the recording of the first instance of distribution of the first portion of the resources in the second distributed ledger is accessible only to users with permissioned access to the second distributed ledger. A validation may also be necessary either by the network operator(s) or by a clearly defined set protocol implemented by the entity. In this way, while the information associated initial transfer of resources to the cryptographic digital wallet and its subsequent transfer to the resource repository as recorded in the first distributed ledger may identify the user, information associated any subsequent transfer of resources from the resource repository is severed from public disclosure requirements of the first distributed ledger. While it would not be impossible to tie transactions back to the user, it would require additional official permission for divulgence. This further allows the entity, i.e., the financial institution to continue to operate as a node in the first distributed ledger, while providing data privacy to the users preventing any unauthorized data exfiltration.

Similarly, to record the first instance of distribution of the first portion of the resources in the second distributed ledger, the system may be configured to generate a second transaction object for the first instance of distribution of the first portion of the resources, and then deploy the second transaction object in the second distributed ledger. To deploy the second transaction object, the system may be configured to capture the second distributed ledger address associated with the recording, and then notify the user and the entity, i.e., financial institution, of the deployment by providing the second distributed ledger address.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, a computer-implemented process is thus produced, such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for obfuscation of network identity to prevent data exfiltration, the system comprising:
at least one non-transitory storage device; and
at least one processor coupled to the at least one non-transitory storage device, wherein the at least one processor is configured to:
receive, from an external device, a first instance of transfer of resources to a user;
store the resources in a cryptographic digital wallet associated with the user;
record the first instance of the transfer of the resources in a first distributed ledger, wherein the first distributed ledger is a public distributed ledger;
automatically transfer the resources from the cryptographic digital wallet to a resource repository associated with the user;
record the transfer of the resources from the cryptographic digital wallet to the resource repository in the first distributed ledger;
electronically receive, from a user input device, a first instance of distribution of a first portion of the resources from the resource repository to an end-point device; and
record the first instance of distribution of the first portion of the resources in a second distributed ledger, wherein the second distributed ledger is a private distributed ledger associated with an entity.

2. The system of claim 1, wherein the at least one processor is further configured to:
electronically receive, from a user input device, a first private key associated with the cryptographic digital wallet; and
execute, using the first private key, the transfer of the resources from the cryptographic digital wallet to the resource repository.

3. The system of claim 1, wherein recording the transfer of the resources from the cryptographic digital wallet to the resource repository in the first distributed ledger further comprises:
generating a first transaction object for the transfer of the resources; and
deploying the first transaction object in the first distributed ledger.

4. The system of claim 3, wherein deploying the first transaction object further comprises:
capturing a first distributed ledger address associated with the recording;
generating a first notification indicating that the first transaction object has been created for the transfer of resources in the first distributed ledger, wherein the first notification comprises at least the first distributed ledger address; and
transmit control signals configured to cause the user input device to display the first notification.

5. The system of claim 4, wherein the recording of the transfer of the resources from the cryptographic digital wallet to the resource repository in the first distributed ledger is publicly accessible.

6. The system of claim 1, wherein recording the first instance of distribution of the first portion of the resources in the second distributed ledger further comprises:
generating a second transaction object for the first instance of distribution of the first portion of the resources; and
deploying the second transaction object in the first distributed ledger.

7. The system of claim 6, wherein deploying the second transaction object further comprises:
capturing a second distributed ledger address associated with the recording;
generating a second notification indicating that the second transaction object has been created for the transfer of resources in the second distributed ledger, wherein the second notification comprises at least the second distributed ledger address; and
transmitting control signals configured to cause the user input device to display the second notification.

8. The system of claim 7, wherein the recording of the first instance of distribution of the first portion of the resources in the second distributed ledger is accessible only to users with permissioned access to the second distributed ledger.

9. A computer program product for obfuscation of network identity to prevent data exfiltration, the computer program product comprising a non-transitory computer-readable medium comprising code causing an apparatus to:
receive, from an external device, a first instance of transfer of resources to a user;
store the resources in a cryptographic digital wallet associated with the user;
record the first instance of the transfer of the resources in a first distributed ledger, wherein the first distributed ledger is a public distributed ledger;
automatically transfer the resources from the cryptographic digital wallet to a resource repository associated with the user;
record the transfer of the resources from the cryptographic digital wallet to the resource repository in the first distributed ledger;
electronically receive, from a user input device, a first instance of distribution of a first portion of the resources from the resource repository to an end-point device; and
record the first instance of distribution of the first portion of the resources in a second distributed ledger, wherein the second distributed ledger is a private distributed ledger associated with an entity.

10. The computer program product of claim 9, wherein the apparatus is further configured to:
electronically receive, from a user input device, a first private key associated with the cryptographic digital wallet; and
execute, using the first private key, the transfer of the resources from the cryptographic digital wallet to the resource repository.

11. The computer program product of claim 9, wherein recording the transfer of the resources from the cryptographic digital wallet to the resource repository in the first distributed ledger further comprises:
generating a first transaction object for the transfer of the resources; and
deploying the first transaction object in the first distributed ledger.

12. The computer program product of claim 11, wherein deploying the first transaction object further comprises:
capturing a first distributed ledger address associated with the recording;
generating a first notification indicating that the first transaction object has been created for the transfer of resources in the first distributed ledger, wherein the first notification comprises at least the first distributed ledger address; and
transmit control signals configured to cause the user input device to display the first notification.

13. The computer program product of claim 12, wherein the recording of the transfer of the resources from the cryptographic digital wallet to the resource repository in the first distributed ledger is publicly accessible.

14. The computer program product of claim 9, wherein recording the first instance of distribution of the first portion of the resources in the second distributed ledger further comprises:
generating a second transaction object for the first instance of distribution of the first portion of the resources; and
deploying the second transaction object in the first distributed ledger.

15. The computer program product of claim 14, wherein deploying the second transaction object further comprises:
capturing a second distributed ledger address associated with the recording;
generating a second notification indicating that the second transaction object has been created for the transfer of resources in the second distributed ledger, wherein the second notification comprises at least the second distributed ledger address; and
transmitting control signals configured to cause the user input device to display the second notification.

16. The computer program product of claim 15, wherein the recording of the first instance of distribution of the first portion of the resources in the second distributed ledger is accessible only to users with permissioned access to the second distributed ledger.

17. A method for obfuscation of network identity to prevent data exfiltration, the method comprising:
receiving, from an external device, a first instance of transfer of resources to a user;
storing the resources in a cryptographic digital wallet associated with the user;
recording the first instance of the transfer of the resources in a first distributed ledger, wherein the first distributed ledger is a public distributed ledger;
automatically transferring the resources from the cryptographic digital wallet to a resource repository associated with the user;
recording the transfer of the resources from the cryptographic digital wallet to the resource repository in the first distributed ledger;
electronically receiving, from a user input device, a first instance of distribution of a first portion of the resources from the resource repository to an end-point device; and
recording the first instance of distribution of the first portion of the resources in a second distributed ledger, wherein the second distributed ledger is a private distributed ledger associated with an entity.

18. The method of claim 17, wherein the method further comprises:
electronically receiving, from a user input device, a first private key associated with the cryptographic digital wallet; and
executing, using the first private key, the transfer of the resources from the cryptographic digital wallet to the resource repository.

19. The method of claim 17, wherein recording the transfer of the resources from the cryptographic digital wallet to the resource repository in the first distributed ledger further comprises:
generating a first transaction object for the transfer of the resources; and
deploying the first transaction object in the first distributed ledger.

20. The method of claim 19, wherein deploying the first transaction object further comprises:
capturing a first distributed ledger address associated with the recording;
generating a first notification indicating that the first transaction object has been created for the transfer of resources in the first distributed ledger, wherein the first notification comprises at least the first distributed ledger address; and
transmitting control signals configured to cause the user input device to display the first notification.
